(19) United States
(12) Patent Application Publication
(10) Pub. No.: US 2006/0055356 A1
(43) Pub. Date: Mar. 16, 2006

(54) No load motor cutoff method and apparatus

(76) Inventors: Thomas Charles McNulty, Ewing, NJ (US); Joacine Plaisime, Trenton, NJ (US)

Correspondence Address: WorldWater Corp., 55 Route 31 South, Pennington, NJ, 08534, US

(21) Appl. No.: 10/938,829

(22) Filed: Sep. 10, 2004

(51) Int. Cl. H02P 3/00

(52) U.S. Cl. 318/474

(57) ABSTRACT

A motor is shut off when its operation encounters no load conditions, e.g. low water conditions for a submersible pump motor. The shutoff signal is obtained from the motor frequency and motor power. When motor frequency exceeds the rated frequency and motor power drops to a preselected level below rated power, a shutoff signal is produced. The motor can be kept off for a preselected period of time before attempting to restart.

### BACKGROUND OF THE INVENTION

The invention relates generally to submersible AC motors for pumping water from wells or other AC motors for driving other loads, and more particularly to method and apparatus for protecting these motors under low water conditions or other no load conditions.

AC motors, whether single phase or multiphase, are used in wells to pump water above ground. The pumps are placed at a certain depth in the wells, normally submerged in the water, and are driven by an associated motor. The motor and pump may form an integrated unit.

One critical concern in using these pumps is control of the pump when the water level is low and remains low for a given period of time. When this low water condition occurs, the pump is no longer submerged in the water and no water is pumped, i.e. there is no load on the motor. The motor will then run overheated and eventually will burn out.

Some form of protection must be provided to remove this fault condition. Usually this protection is provided in the form of a float switch to control the AC power to the motor. If a motor is pumping water and the water level drops below the pumping level, the float switch will also drop and interrupt the AC power to the motor, shutting off the motor.

A float switch is mechanical in operation and can provide proper protection for the motor. However, the float switch must be located down the well at the pump level with separate wiring. For installation and maintenance purposes this creates problems, particularly when the pump is located in a deep well, e.g. hundreds of feet underground. For maintenance, both the motor and float switch must be brought to the surface, and for installation, the float switch must be correctly positioned relative to the motor. In operation, the float switches may become entangled with debris or corrode in the water, and not function properly.

Other AC motors driving other loads have similar needs to be shut off under prolonged no load conditions. If the motor continues to operate too long without a load, it may be severely damaged, and need to be repaired or replaced.

Thus it is desired to provide an improved method and apparatus for protecting the AC motors of submersible water pumps during low water conditions. It is particularly desirable to eliminate the mechanical problems associated with float switches. Similarly, it is also desired to protect other AC motors under other no load conditions.

### SUMMARY OF THE INVENTION

Accordingly it is an object of the invention to provide low water protection for a submersible AC motor driving a water pump, or other no load protection for other AC motors.

The invention is a method and apparatus, implemented in either hardware or hardware and software, to shut off a submersible AC motor used to drive a water pump, during low water conditions when the water level falls below the pumping level, or to shut off another AC motor under other no load conditions. According to the invention, this control of the AC motor is accomplished above ground. The invention is readily adaptable to, but not limited to, the use of solar power to drive the AC motor. Variable speed AC drives are also easily adapted to use the invention for low water or other no load control.

According to the invention, motor speed and power are sensed to determine when a low water or other no load condition has occurred. When a combination of sufficiently high motor speed and sufficiently low motor power occurs, a control signal is produced which shuts off the motor. The motor speed and power can be detected at the power source, e.g. a solar array. Array voltage is a measure of motor frequency and array current is a measure of motor power.

### BRIEF DESCRIPTION OF THE DRAWINGS

In the accompanying drawings:

FIG. 1 is a schematic diagram of a circuit according to the invention for producing a low water shutoff or other no load control signal for an AC pump motor or other AC motor.

FIG. 2 is a schematic diagram of a timer circuit for applying the output of the control circuit of FIG. 1 to a motor driver.

FIG. 3 is a schematic diagram of an alternate embodiment of the invention, using a combination of hardware and software.

FIG. 4 is a schematic diagram of the sense resistor connected to a solar array and motor drive.

FIG. 5 is a block diagram of a solar powered water pumping system which can utilize the invention.

### DESCRIPTION OF THE INVENTION

The invention is particularly directed to AC motors for water pumps when low water conditions occur, and is described primarily with respect thereto, but applies equally to other AC motors driving other kinds of loads when other no load conditions occur, so that the term “low water” may be generally taken to mean “no load”. The invention is also particularly directed to solar power as the power source to drive the motor but also applies to- other power sources.

Empirical data has shown that when an AC pump motor operates at rated power and at rated speed, the motor has sufficient load and is pumping water. For variable speed AC drives, should the motor operate at lower speeds and at reduced power, the motor is still under load and pumping water. However, when the motor is operating without a load, i.e. no water, tests have shown that the motor frequency is maximum, i.e. 60 Hz or higher, and the power level is at or near zero. This information is utilized in the invention to produce a shutoff signal to control the motor.

According to the invention, when the motor is operating without load at the low water (or other no load) condition, sensing motor speed and power is used to provide a control signal and shut off the motor, to prevent the motor from burning up and save costly repairs or replacement. And the motor speed and power can be sensed at the power source, e.g. solar array, rather than at the motor itself.

The invention includes a method for shutting off a motor when its operation changes from load to no load conditions, by obtaining signals based on motor frequency and motor power; producing a shutoff signal when both the motor frequency exceeds a preselected frequency and the motor power decreases below a preselected power; and applying the shutoff signal to the motor. The method further can include keeping the motor shut off for a preselected time after applying the shutoff signal. The motor frequency based signal can be obtained by detecting a change of source voltage above a preselected level and the motor power based signal can be obtained by detecting a change of source current below a preselected level.

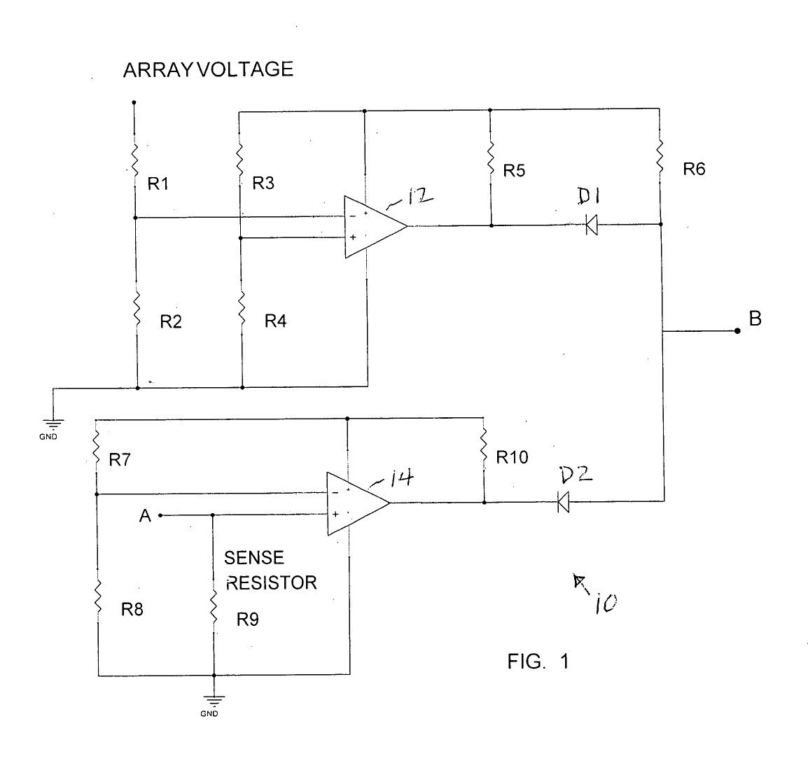

FIG. 1 shows a circuit 10 for providing a low water shutoff control signal to an AC pump motor. Circuit 10 has two comparators. 12, 14 connected through blocking diodes D1, D2 respectively to common node B. Since diodes D1, D2 are in a blocking position, when the output of either (or both) of the comparators 12, 14 is low, the corresponding diode D1, D2 is forward biased and becomes conducting, making the voltage at node B go low. However, when the outputs of both comparators 12, 14 are high, the diodes D1, D2 are reverse biased and become nonconducting, so that the voltage at node B goes high (Vcc). Therefore, only when both comparators 12, 14 are high is the output through diodes D1, D2 at common node B high. This combination is used to determine the low water condition.

Comparator 14 has a sense resistor R9 (or other current sense element) connected to one of its inputs. Sense resistor R9 is in series with the return leg of the solar array used to power the motor, so it senses current through the array. As shown in FIG. 4 sense resistor R is connected in series with a motor drive 40 to a solar array; the current through R is a measure of the power drawn from the array. (The circuit 10 is described herein with respect to using a solar array to power the motor, but other power sources may also be used.) The voltage trip point is set at the other input of comparator 14, so that at some percentage, e.g. 25%, of rated current or less, the comparator 14 will go high. Above this point, e.g. 25%, the comparator 14 is low. This establishes one condition for the low water cutoff.

The second condition is sensing the array voltage, which is done with comparator 12. Array voltage is a measure of motor speed. The voltage divider formed of resistors R1, R2 is connected to the solar array voltage, which typically varies between about 200V-600V. The node between R1, R2 is connected to an input of comparator 12. The voltage trip point is set at the other input of comparator 12 to the open circuit voltage of the solar array. Therefore, the comparator 12 output voltage is low when the solar array is at nominal voltage, and will go high when the solar panel is at zero current.

Summing the two conditions from comparators 12, 14 into an AND function will provide a DC level that is high only when a combination of both low power and open circuit array voltage is present. These conditions correspond to operation of the motor under low water conditions. Thus the summed level from the pair of comparators 12, 14 can be used to shut down the AC motor under low water conditions. The outputs of the comparators 12, 14 are determined from inputs from the solar power source.

Thus, the apparatus for shutting off a motor driven by a power source when its operation changes from load to no load conditions includes two circuits. A sensing circuit is coupled to the power source for detecting source voltage and source power. A cutoff generating circuit is coupled to the sensing circuit to produce a motor shutoff signal when the source voltage is above a preselected value and the source power is below a preselected value.

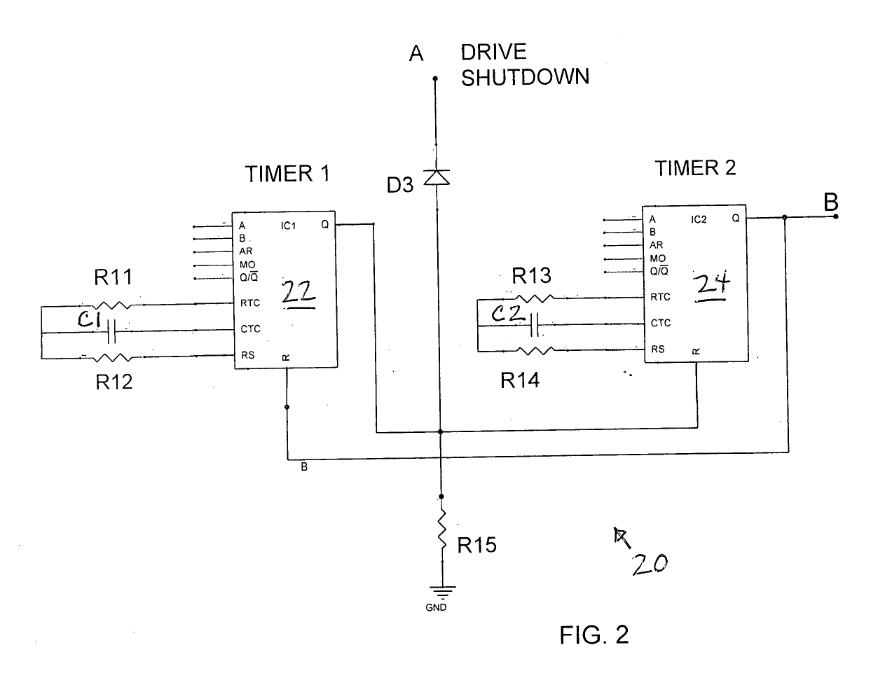

Once the low water condition has been established, the control signal from node B of circuit 10 is applied through a timing circuit 20, shown in FIG. 2, to shut down the AC motor. While the control signal at node B could be directly applied to shut off the motor, it is preferable to go through a timing circuit such as timing circuit 20 to prevent the motor from constantly being turned on and off due to rapidly fluctuating changes in water level near the low water point. The timing circuit will keep the motor off for a preselected time and then check if the low water condition still exists.

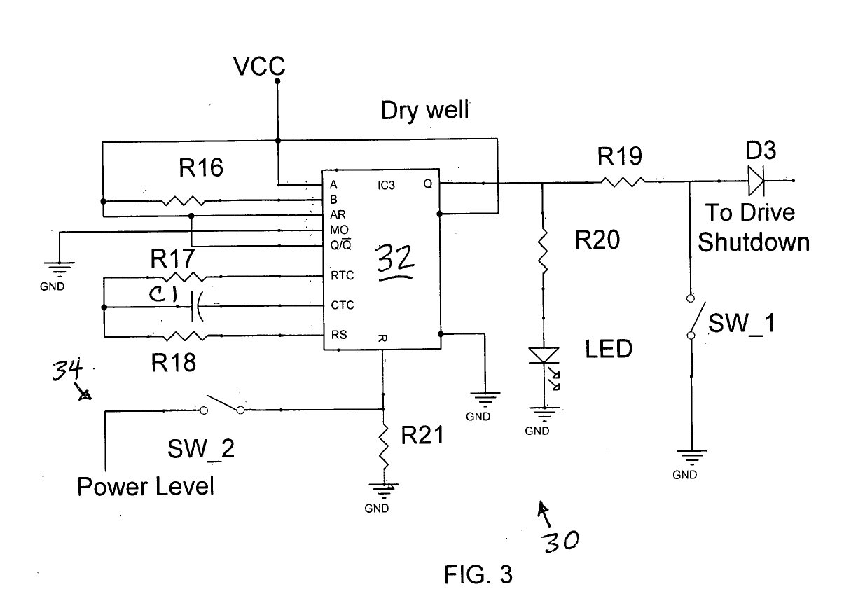

Timing circuit 20 has two timers 22, 24 connected to node B of FIG. 1, and is actuated by the control signal from circuit 10 of FIG. 1. The output of timer 22 is connected through a diode D to the motor drive and also to the reset input of timer 24 whose output is connected to node B. When the control signal for motor shutoff (high level at node B) is applied to the reset input of (first) timer 22, its output shuts off the motor for a preselected time, e.g. 30 min. At the same time, the output of timer 22 is connected to (second) timer 24 whose output will change for a preselected time, e.g. 30 sec-2 min, after timer 22 has timed out. Node B is held low for this time so circuit 10 is in motor running condition. The purpose of timer 24 is to force the motor to turn back on in order to reach speed and determine if the water level has risen for the motor to operate at rated power. When either power or less than open circuit voltage appears on the sensing comparator! rs of circuit 10, the AC motor will continue to operate since the node B will go low and timers 22, 24 will be inactivated. However, if the low water condition still exists, node B will go high, and timer 22 will turn off the motor again, and the timing cycle will be repeated. Timers 22, 24 may be implemented with digital IC timer chips, e.g. CD4541. The internal frequency and time period of the timers can be set as shown in more detail in FIG. 3.

An alternative to the hardware implementation of the invention shown in FIGS. 1-2 is a hardware and software implementation shown in FIG. 3. The invention is still based on a combination of motor speed (frequency) and power reaching certain limits. Some variable speed AC drives provide output functions that track speed and power. For example, in some drives there is an output relay circuit which is normally open but can be programmed to close at a preselected speed. Also available is an analog circuit which provides a DC ramp voltage as a function of motor power. With these conditions available, the sensing functions performed in FIGS. 1-2 to sense water level can be carried out.

Timing circuit 30 in FIG. 3 is based on an IC timer chip 32, e.g. a CD4541. The reset input of timer 32 is connected to a sensing circuit 34 which receives motor speed and power information from the motor drive. Sensing circuit 34 includes a switch (or relay) SW2 which is normally open, and closes when the motor frequency reaches a preselected frequency, e.g. 65 Hz, which is indicative of the low water condition. A motor power level signal from the driver is applied to the sensing circuit 34 to the reset input of timer 32 when switch SW2 is closed. A sufficiently low power level signal, e.g. 20%, will trigger the timer 32. Thus the combination of low power and high frequency conditions are ANDed together to actuate the timer 32 to provide a motor drive shutdown signal. An LED is included at the output of timer 32 a a low water level indicator. Other alarms or indicators can also be actuated by the shutdown signal. Shorting switch SW1 is used for initial setup or maintenance. The remaining circuitry connected to timer chip 32 are an oscillator for the chip to set up an internal frequency and biasing circuitry to set the time period for the timer, e.g. 30 min. When timer 32 completes the time cycle, the sense circuit will determine if water is available and if so, allow the motor to run. If not, it will shut down the motor.

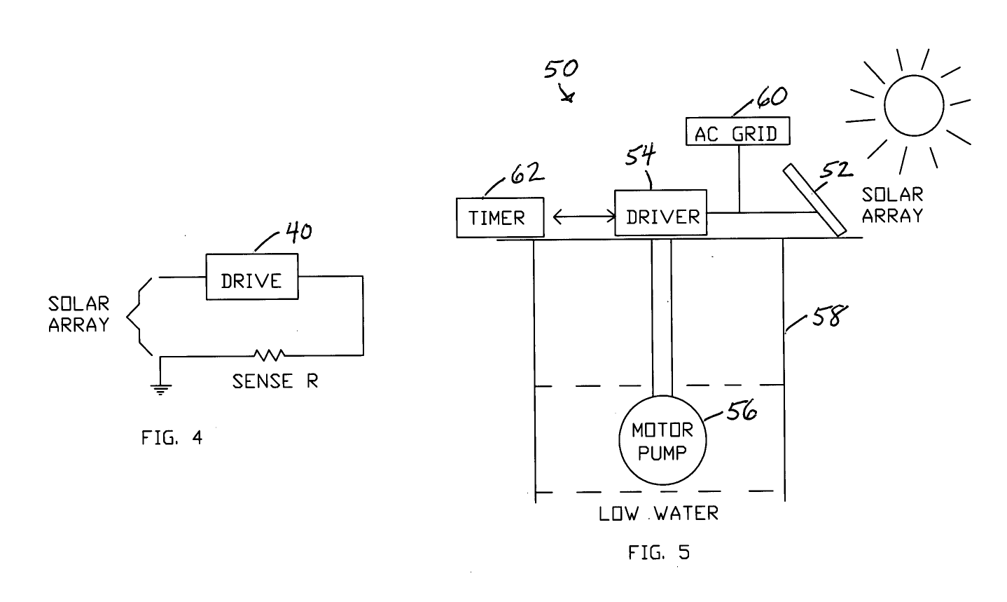

FIG. 5 shows a general representation of a complete solar power water pumping system 50 which can utilize the invention to shut off the motor under low water conditions. Solar array 52 produces DC power which is converted into variable frequency AC power by driver 54. Driver 54 powers an AC motor 56 which is positioned in a well 58 to pump water. Driver 54 can also receive power from the AC grid 60 when solar array 52 produces insufficient power (and excess DC power from the array 52 can be net metered to the grid 60 when not needed to drive motor 56. Driver 54 is based on a conventional variable speed motor drive, and can be modified to incorporate the present invention so that driver 54 shuts off when a low water condition signal is produced. Thus the circuitry to produce the shutoff signal is located above ground as part of the motor drive. For example, the sensing and control signal producing circuits of FIGS. 1-2, or the system of FIG. 3, can be included in the driver 54. A timer element 62, which may be built integrally into the driver 54, provides the timing functions of FIGS. 2 or 3 to keep the driver 54 off for a selected period-of time.

In summary, the invention is based on determining when a motor is under a no load condition from motor frequency (speed) and power. A motor under load (e.g. water present to be pumped) will operate at a frequency of 60 Hz (the rated frequency) or less, and at a significant power level (at least a significant fraction of rated power). When there is no load (e.g. no water to be pumped) the speed increases over 60 Hz, and the power drops significantly below the rated power. A threshold value of 20% rated power has been selected as the cutoff condition (but other values can be chosen). The invention includes any apparatus and method that utilizes the combination of high speed and low power conditions to produce a motor drive shut off signal. The invention is not limited by any particular apparatus, whether primarily hardware or hardware and software implementations, or by any particular method of producing the shut off signal from motor frequency and power. The shut off signal actuates a timer which shuts off the motor for a preselected period of time.

Changes and modifications in the specifically described embodiments can be carried out without departing from the scope of the invention which is intended to be limited only by the scope of the appended claims.

1. Apparatus for shutting off a motor when its operation changes from load to no load conditions, comprising:
a no load condition sensing circuit for determining the combination of motor frequency at a preselected level above the rated frequency and a motor power at a preselected level below the rated power, and producing a shutoff signal therefrom;
a timing circuit connected to the sensing circuit for applying the shutoff signal to the motor and keeping the motor off for a preselected period of time.

2. The apparatus of claim 1 wherein the sensing circuit comprises:
a first comparator having one input connected to a preselected fraction of the source voltage and a second input connected to a trip point determining circuit so that the first comparator produces a low output when the source voltage goes above a preselected level;
a second comparator having one input connected to a current sense element which is connected in series with the power source and motor drive and a second input connected to a trip point determining circuit so that the second comparator produces a low output when the source current drops below a preselected value;
the outputs of the first and second comparators being connected in an AND gate configuration.

3. The apparatus of claim 2 wherein the outputs of the first and second comparators are connected to a common node through blocking diodes.

4. The apparatus of claim 1 wherein the timing circuit comprises a first timer responsive to the sensing circuit for shutting off the motor for a first preselected period and a second timer for turning the motor on for a second preselected period after the first preselected period.

5. The apparatus of claim 1 wherein the timing circuit comprises a timing chip and the sensing circuit comprises an input circuit connected to the timing chip and responsive to power level and motor frequency signals from a motor drive.

6. The apparatus of claim 5 wherein the input circuit comprises an input node connected to the power level signal and a normally open series switch which is actuated by a motor frequency signal.

7. A method for shutting off a motor when its operation changes from load to no load conditions, comprising:
obtaining signals based on motor frequency and motor power;
producing a shutoff signal when both the motor frequency exceeds a preselected frequency and the motor power decreases below a preselected power;
applying the shutoff signal to the motor.

8. The method of claim 7 further comprising keeping the motor shut off for a preselected time after applying the shutoff signal.

9. The method of claim 7 wherein the motor frequency based signal is obtained by detecting a change of source voltage above a preselected level and the motor power based signal is obtained by detecting a change of source current below a preselected level.

10. The method of claim 7 wherein the motor frequency and motor power based signals are obtained from a motor drive.

11. Apparatus for shutting off a motor driven by a power source when its operation changes from load to no load conditions, comprising:
a sensing circuit coupled to the power source for detecting source voltage and source power;
a cutoff generating circuit coupled to the sensing circuit to produce a motor shutoff signal when the source voltage is above a preselected value and the source power is below a preselected value.

12. The apparatus of claim 11 further comprising a timing circuit for keeping the motor shut off for a preselected period of time after receipt of the motor shutoff signal.
